(19) United States
(12) Patent Application Publication
(10) Pub. No.: US 2011/0157008 A1
(43) Pub. Date: Jun. 30, 2011

(54) DEVICE-CONTROL SYSTEM, TERMINAL APPARATUS, AND DEVICE

(75) Inventor: Yutaka MARUYAMA, Ichikawa-shi (JP)

(73) Assignee: Buffalo Inc., Nagoya-shi (JP)

(21) Appl. No.: 12/977,448

(22) Filed: Dec. 23, 2010

(30) Foreign Application Priority Data
Dec. 24, 2009 (JP) 2009-293128

(51) Int. Cl. G09G 5/00

(52) U.S. Cl. 345/156

(57) ABSTRACT

A device-control system includes a device operated by a remote controller and a terminal apparatus displaying an image. The device-control system controls the device via a network. The terminal apparatus includes an output section, a terminal's receiver for receiving an image similar to the appearance of the remote controller for operating the device, a terminal's output processor for controlling the output section to output the image received by the terminal's receiver, and a terminal's transmitter for transmitting operational information generated by an operation performed by use of the terminal apparatus with respect to the image outputted by the output section. The device includes a device's processor for performing processing in accordance with the operational information.

### CROSS REFERENCE TO RELATED APPLICATIONS

This application is based upon and claims the benefit of priority from prior Japanese Patent Application No. 2009-293128, filed on Dec. 24, 2009; the entire contents of which are incorporated herein by reference.

### BACKGROUND OF THE INVENTION

1. Field of the Invention

The invention relates to a device-control system to control a device that is operable by use of a remote controller, a terminal apparatus, and a device.

2. Description of the Related Art

In recent years, remote controls are appertained to various devices in home. The user can operate remotely the devices by operating their respective remote controls. In addition, the following technique has been proposed (see, for example, Japanese Unexamined Patent Application Publication No. 2001-148889). In the proposed technique, an interface that is common to various devices in a house is displayed on a screen by use of a web browser, and the user uses the common interface for performing the overall control on those devices.

However, according to the technique described above, even those users that have already mastered how to operate each of the remote controls corresponding to the various devices must learn, from the start, how to operate the common interface. In addition, operating a particular device by using the common interface, which is different from the remote controller that accompanies the particular device, confuses the user especially when the user is familiar with the operation of the accompanying remote controller and may cause the user to operate the device incorrectly.

### SUMMARY OF THE INVENTION

According to a first aspect of the present invention, there is provided a device-control system which includes a device capable of being operated by a remote controller and a terminal apparatus capable of displaying an image, and which controls the device via a network, wherein the terminal apparatus includes an output section; a terminal's receiver for receiving an image similar to an appearance of the remote controller for operating the device; a terminal's output processor for causing the output section to output the image received by the terminal's receiver; and a terminal's transmitter for transmitting the operational information generated by an operation performed by use of the terminal apparatus with respect to the image outputted by the terminal's output processor, and wherein the device includes a device's processor for performing processing operations in accordance with the operational information.

According to the device-control system, an image similar to the appearance of the remote controller is displayed in the terminal apparatus. Accordingly, by manipulating the displayed image, the user can operate the device as if the user were actually operating the remote controller. Consequently, the user can operate the device easily.

According to a second aspect of the present invention, there is provided a device-control system as provided according to the first aspect of the invention, wherein the terminal's receiver receives an image similar to the appearance of the remote controller for operating the device.

According to a third aspect of the present invention, there is provided a device-control system as provided according to the first aspect of the invention, wherein the terminal's receiver receives the image from the device, and the terminal's transmitter transmits the operational information to the device.

According to a fourth aspect of the present invention, there is provided a device-control system as provided according to the third aspect of the invention, wherein the terminal's transmitter transmits as operational information a processing command that is dedicated to the device and that corresponds to the coordinate information representing a selected position on the image, and wherein the device's processor performs processing in accordance with the processing command as the operation information received from the terminal apparatus and serving as the operational information.

According to a fifth aspect of the present invention, there is provided a device-control system as provided according to the third aspect of the invention, wherein the terminal's transmitter transmits as operational information the coordinate information indicating a point selected on the image to the device, and the device's processor performs processing in accordance with a processing command dedicated to the device and corresponding to the coordinate information as the operational information received from the terminal apparatus.

According to a sixth aspect of the present invention, there is provided a device-control system as provided according to the third aspect of the invention, further comprising a link server for linking the terminal apparatus to the device.

According to the device-control system, even if the user does not know the URL of each of the devices, the user can access each of the devices as long as the user knows the URL of the link server.

According to a seventh aspect of the present invention, there is provided a device-control system as provided according to the first aspect of the invention, further comprising a management server for managing the device, wherein the terminal's receiver receives the image from the management server, and the terminal's transmitter transmits the operational information to the management server.

According to an eighth aspect of the present invention, there is provided a device-control system as provided according to the seventh aspect of the invention, wherein the management server includes a server's operational-information transmitter; the terminal's transmitter transmits that processing command as the operational information which is dedicated to the device and corresponds to the coordinate information indicating a point selected on the image; the server's operational-information transmitter transmits to the device the processing command received from the terminal apparatus and serving as the operational information; and the device's processor performs processing in accordance with the processing command received from the management server and serving as the operational information.

According to a ninth aspect of the present invention, there is provided a device-control system as provided according to the seventh aspect of the invention, wherein the management server includes a server's operational-information transmitter: the terminal's transmitter transmits to the management server the coordinate information indicating a point selected on the image and serving as the operational information; the server's operational-information transmitter transmits to the device that processing command dedicated to the device which serves as the operational information and corresponds to the coordinate information received from the terminal apparatus; and the device's processor performs processing in accordance with the processing command received from the management server and serving as the operational information.

According to a tenth aspect of the present invention, there is provided a device-control system as provided according to the first aspect of the invention, wherein the terminal's output processor causes the output section to output explanatory information providing explanation corresponding to the coordinate information indicating a point selected on the image.

According to the device-control system, even if the user is not accustomed to the remote controller, the description by use of the balloon, voice, movie, or the like outputted when each of the buttons in the appearance image is clicked, allows the user to make sure how to operate the device.

According to an eleventh aspect of the present invention, there is provided a device-control system as provided according to the first aspect of the invention, wherein when a plurality of devices are controlled via the network, the terminal's output processor causes the output section to output display regions to be used for identifying the plural devices in association with the respective devices, and the terminal's output processor causes the output section to output the image associated with the device identified by selecting any one of the display regions.

According to the device-control system, the use of tabs allows the user to operate efficiently plural devices by use of a single web-browser screen.

According to a twelfth aspect of the present invention, there is provided a device-control system as provided according to the first aspect of the invention, wherein the device further includes a device-state transmitter; the terminal apparatus further includes a terminal's device-state receiver and a terminal's device-state output processor; the device-state transmitter transmits state information indicating the current state of the device; the terminal's device-state receiver receives the state information; and the terminal's device-state output processor causes the output section to output an image corresponding to the state information received by the terminal's device-state receiver.

According to the device-control system, the user can receive the current status information.

According to a thirteenth aspect of the present invention, there is provided a device-control system as provided according to the twelfth aspect of the invention, wherein when the remote controller includes a display section to display the state information, the terminal's device-state output processor causes the output section to output the image corresponding to the state information received by the terminal's device-state receiver in a region within the image corresponding to the display section.

According to a fourteenth aspect of the present invention, there is provided a terminal apparatus which communicates via a network with a device operable by a remote controller and which displays an image, the terminal apparatus comprising an output section; a terminal's receiver for receiving an image similar to the appearance of the remote controller for operating the device; a terminal's output processor for causing the output section to output the image received by the terminal's receiver; and a terminal's transmitter for transmitting operational information generated by an operation performed by use of the terminal apparatus with respect to the image outputted by the terminal's output processor.

According to a fifteenth aspect of the present invention, there is provided a device which communicates via a network with a terminal apparatus capable of displaying an image and which can be operated by use of a remote controller, the device comprising a device's processor for performing processing in accordance with the operational information if the terminal apparatus displays an image similar to the appearance of the remote controller for operating the device, and transmits the operational information generated by an operation performed with respect to the image by use of the terminal apparatus.

### BRIEF DESCRIPTION OF THE DRAWINGS

FIG. 1 is a diagram illustrating an overall configuration of a device-control system according to a first embodiment of the invention.

FIG. 2 is a block diagram illustrating a configuration of a terminal apparatus according to embodiments of the invention.

FIG. 3 is a first image which is displayed in the terminal apparatus according to the embodiments of the invention and which looks like the appearance of a remote controller used for operating devices.

FIG. 4 is a second image which is displayed in the terminal apparatus according to the embodiments of the invention and which looks like the appearance of an appearance of the remote controller used for operating devices.

FIG. 5 is a diagram illustrating a configuration of either a terminal apparatus or a device's mapping holding section according to embodiments of the invention.

FIG. 6 is a block diagram illustrating a configuration of a device according to the first embodiment of the invention.

FIG. 7 is a flowchart related to the terminal apparatus according to the first embodiment of the invention.

FIG. 8 is a flowchart related to the device according to the first embodiment of the invention.

FIG. 9 is a diagram illustrating an overall configuration of a device-control system according to the second embodiment of the invention.

FIG. 10 is a block diagram illustrating a configuration of a device according to the second embodiment of the invention.

FIG. 11 is a block diagram illustrating a configuration of a management server according to the second embodiment of the invention.

FIG. 12 is a diagram illustrating the configuration of a server's mapping holding section according to embodiments of the invention.

FIG. 13 is a flowchart related to a terminal apparatus according to the second embodiment of the invention.

FIG. 14 is a flowchart related to the management server according to the second embodiment of the invention.

FIG. 15 is a flowchart related to the device according to the second embodiment of the invention.

### DETAILED DESCRIPTION OF THE EMBODIMENTS

Then, first and second embodiments of the invention will be described in referring to the drawings. Throughout drawings of the embodiments described below, sections that are either same or similar to each other are denoted by the same or similar reference numerals. In the following embodiments, an appearance image similar to that of the remote controller used for operating a device is displayed as a web content by use of a web browser on a screen. Note that an appearance image described as an image with the same appearance as a remote controller to operate the corresponding device includes an image that is actually different from the remote controller. For example, the sizes of the buttons may be different between the appearance image and the actual remote controller or the appearance image has no mark of the manufacturer that the actual remote controller has.

### First Embodiment

Now, description will be given of the following points according to a first embodiment of the invention: (1) the overall configuration of a device-control system; (2) the configurations of a terminal apparatus and of a device; (3) operations of the terminal apparatus and of the device; and (4) advantageous effects.

### (1) Overall Configuration of Device-Control System

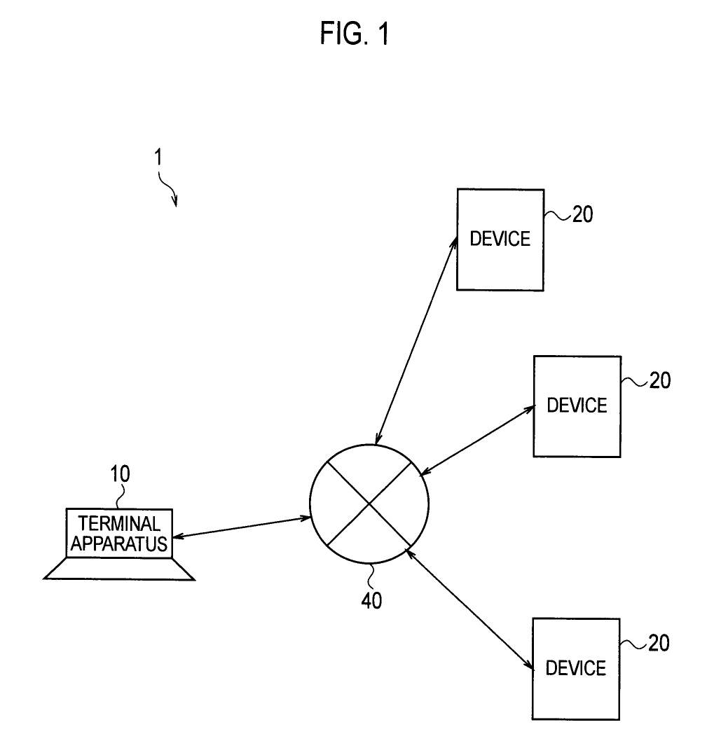

FIG. 1 is a diagram illustrating the overall configuration of a device-control system 1 according to the first embodiment of the invention.

As FIG. 1 shows, the device-control system 1 includes a terminal apparatus 10, devices 20, and a network 40, such as the Internet, and a LAN.

The terminal apparatus 10 requires an appearance image to operate the device 20 of the device 20, via the network 40. Then, the terminal apparatus 10 receives the image from the device 20 and displays the image. The terminal apparatus 10 transmits operational information to the device 20 via the network 40. The operational information is based on the operation on the displayed image in the terminal apparatus 10. Note that the terminal apparatus 10 may be a portable terminal apparatus.

The device 20 receives the operational information from the terminal apparatus 10 via the network 40, and then performs processing in accordance with the operational information.

### (2) Configurations of Terminal Apparatus and of Device

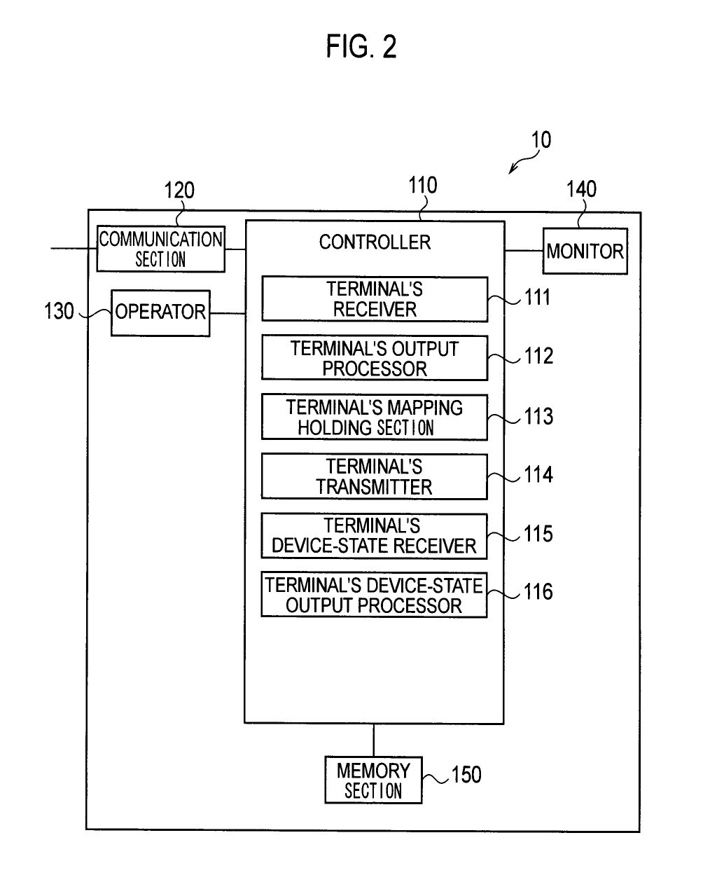

FIG. 2 is a block diagram illustrating the configuration of the terminal apparatus 10 according to the first embodiment of the invention.

The terminal apparatus 10 shown in FIG. 2 makes the device 20 perform processing in response to an operation performed by the user on the appearance image to operate the device 20. The terminal apparatus 10 is, for example, a personal computer. The terminal apparatus 10 includes a controller 110, a communication section 120, an operator 130, a monitor 140, and a memory section 150.

The controller 110 consists of a CPU, for example, and controls the variety of functions that the terminal apparatus 10 has.

The communication section 120 communicates with the device 20 via the network 40.

The operator 130 consists of a numerical keypad, function keys, and the like, and provides an interface used by the user to input the operational content. In addition, the operator 130 may consists of a mouse, which is a pointing device to be used, for example, to select a character string or the like displayed on the monitor 140.

The monitor 140 displays, for example, the image received via the controller 110, or the operational content.

The memory section 150 consists of a memory, for example, and stores a variety of information to be used in the control performed by the terminal apparatus 10.

The controller 110 includes a terminal's receiver 111, a terminal's output processor 112, a terminal's mapping holding section 113, a terminal's transmitter 114, a terminal's device-state receiver 115, and a terminal's device-state output processor 116.

The terminal's receiver 111 receives an appearance image to operate the device 20 from the device 20 via the network 40. To put it concretely, when the user directly input the URL of the web content associated with the image into the web browser by using the operator 130, the terminal's receiver 111 receives the image.

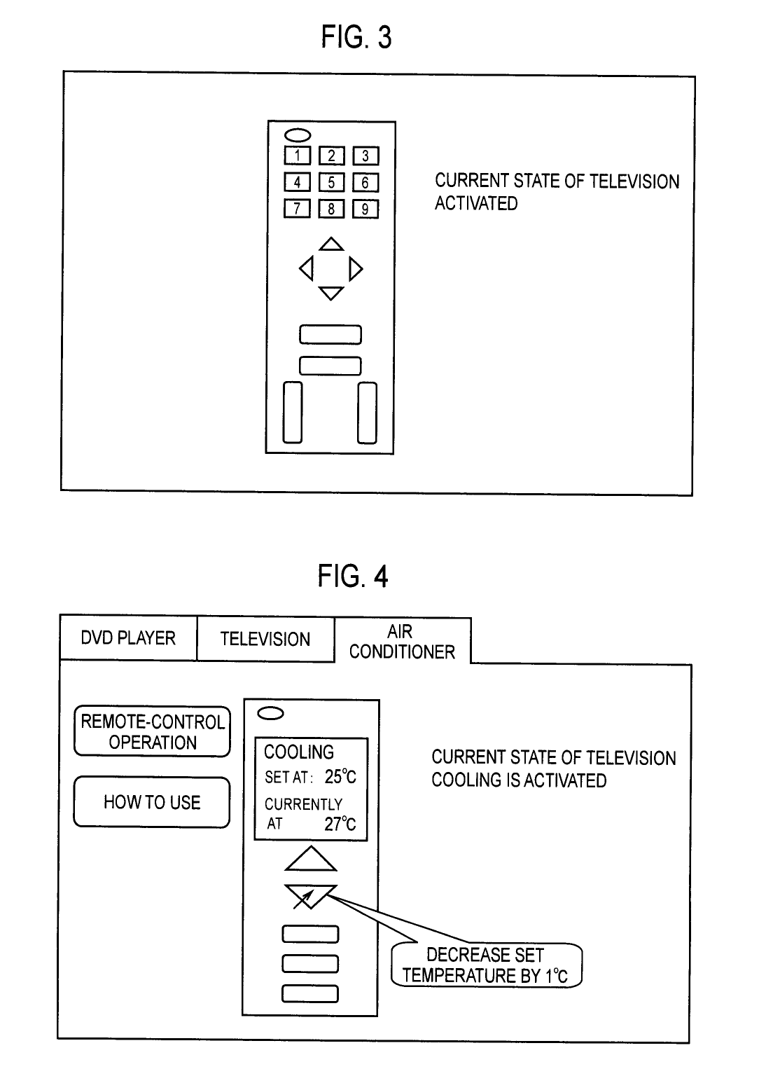

As FIG. 3 shows, the terminal's output processor 112 displays the image received by the terminal's receiver 111 on the monitor 140. In addition, when the terminal apparatus 10 operates simultaneously plural ones of the devices 20 in accordance with the operation by the user, terminal's output processor 112 may display tabs with the names of the plural devices 20 on the monitor as FIG. 4 shows. In this case, if any of the tabs is clicked by use of a mouse or the like of the operator 130, the terminal's output processor 112 displays the appearance image to operate the device 20 associated with the clicked tab on the monitor 140. In addition, if a button or the like of the appearance image is clicked, the terminal's output processor 112 may display the description related to the button or the like on the monitor 140. To put it concretely, as FIG. 4 shows, the monitor 140 displays mode switching buttons of “remote-control operation” and of “how to use.” If the “how to use” button is pressed down and then any of the buttons of the appearance image is clicked, the terminal's output processor 112 explains the button of the appearance image by use of a balloon, voice, movie, or the like. In contrast, if the “remote-control operation” button is pressed down and then any of the buttons of the appearance image is clicked, the terminal's transmitter 114 performs processing.

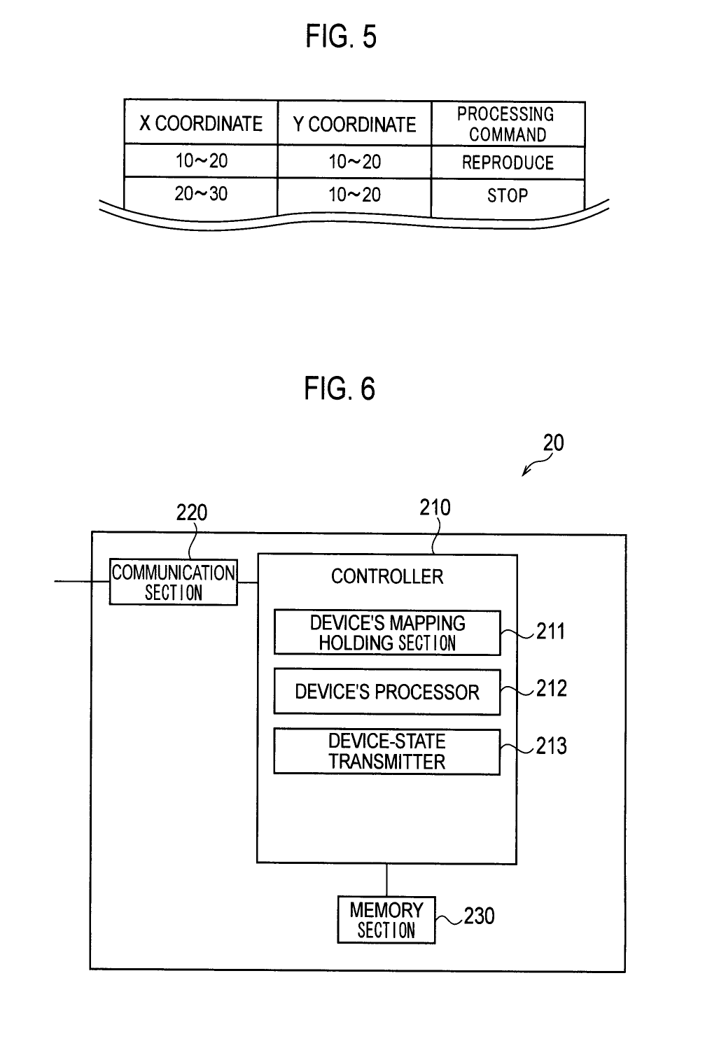

As FIG. 5 shows, the terminal's mapping holding section 113 holds: coordinates in the appearance image to operate devices 20 that the terminal's output processor 112 makes the monitor 140 display; and processing commands which correspond respectively to the coordinates and which are dedicated to the devices 20. The coordinates and the processing commands are made to associate with each other.

The appearance image to operate one of the devices 20 is displayed on the monitor 140 by the terminal's output processor 112. If the appearance image is clicked by use of a mouse or the like of the operator 130, the terminal's transmitter 114 transmits to the device 20 the coordinate information on the clicked point. Alternatively, the terminal's transmitter 114 may transmit to the device 20 a processing command corresponding the coordinates information in the terminal's mapping holding section 113. Note that the coordinate information can be acquired from the type “image” attribute of the input tag of HTML, for example.

The terminal's device-state receiver 115 receives information on the current states of the devices 20 from the devices 20 via the network 40. For example, the information is one that is not displayed on the appearance image to operate the device 20, specifically, information on the fact that the device 20 is not activated and is thus in the OFF state.

As FIG. 3 shows, the terminal's device-state output processor 116 displays the information on the current state of the device 20 received by the terminal's device-state receiver 115 on the monitor 140. In addition, if the remote controller to operate device 20 has its own liquid crystal display (LCD) or the like that displays the current state of the device 20, the terminal's device-state output processor 116 displays the current state of the device 20 at the corresponding section in the appearance image in a manner similar to that shown in the LCD as FIG. 4 shows.

FIG. 6 is a block diagram illustrating the configuration of the device 20 according to the first embodiment of the invention.

The device 20 shown in FIG. 6 performs processing in response to the operation performed by the user on the terminal apparatus 10. The device 20 includes a controller 210, a communication section 220, and a memory section 230.

The controller 210 consists of a CPU, for example, and controls the variety of functions that the device 20 has.

The communication section 220 communicates with the terminal apparatus 10 via the network 40.

The memory section 230 consists of a memory, for example, and stores a variety of information to be used in the control performed on the device 20.

The controller 210 includes a device's mapping holding section 211, a device's processor 212, and a device-state transmitter 213.

As FIG. 5 shows, the device's mapping holding section 211 holds coordinates in the appearance image to operate devices 20 that are transmitted to the terminal apparatus 10 and processing commands which correspond respectively to the coordinates and which are dedicated to the devices 20. The coordinates and the processing commands are made to associate with each other.

The device's processor 212 performs processing on the device 20 in accordance with the processing command dedicated to the device 20. The device 20 receives the processing command from the terminal's transmitter 114 via the network 40. In addition, the coordinates information is received from the terminal's transmitter 114 via the network 40. The coordinates information is associated with the coordinates in the device's mapping holding section 211.

The device-state transmitter 213 transmits information on the current state of the device 20 to the terminal apparatus 10 via the network 40 either periodically or when particular processing on the device 20 is finished. For example, the information is one that is not displayed on the appearance image to operate the device 20, specifically, information on the fact that the device 20 is not activated and is thus in the OFF state.

### (3) Operations of Terminal Apparatus and of Device

Operations of the terminal apparatus and of the device will be described.

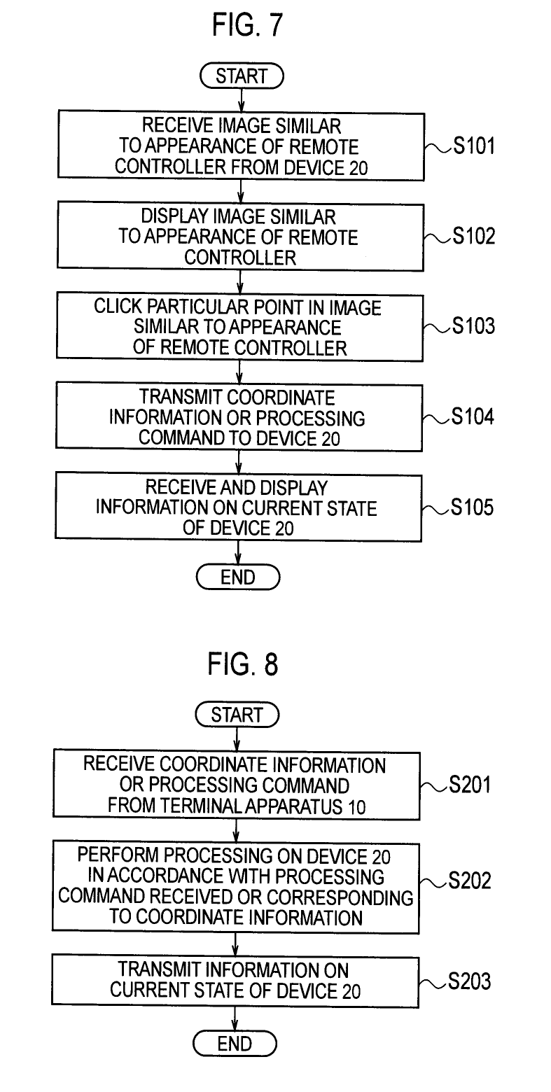

FIG. 7 is a flowchart illustrating the operations of the terminal apparatus.

In step S101, the terminal's receiver 111 receives an appearance image to operate the device 20 from the device 20 via the network 40 once the user directly input the URL of the web content associated with the image into the web browser by using the operator 130.

In step S102, the terminal's output processor 112 displays the appearance image received by the terminal's receiver 111 on the monitor 140.

In step S103, the user clicks, by use of a mouse or the like of the operator 130, a particular point in the appearance image that the terminal's output processor 112 displays on the monitor 140.

In step S104, the terminal's transmitter 114 transmits the coordinate information on the clicked point to the device 20. Alternatively, the terminal's transmitter 114 may transmit, to the device 20, a processing command dedicated to the device 20. The processing command is associated with the coordinates in the terminal's mapping holding section 113 corresponding to the coordinate information.

In step S105, the terminal's device-state receiver 115 receives information on the current state of the device 20 from the device 20 via the network 40. For example, the information is one that is not displayed on the appearance image to operate the device 20, specifically, information on the fact that the device 20 is not activated and is thus in the OFF state. The terminal's device-state output processor 116 displays the information on the current state of the device 20 thus received by the terminal's device-state receiver 115 on the monitor 140. Note that the reception and the display of the information on the current state of the device 20 may be performed at any timing.

FIG. 8 is a flowchart illustrating the operations of the device 20.

In step S201, the controller 210 receives either the coordinate information or the processing command dedicated to the device 20 from the terminal apparatus 10, via the network 40.

In step S202, the device's processor 212 performs processing on the device 20 in accordance with the received processing command. In addition, the device's processor 212 performs processing on the device 20 in accordance with the processing command dedicated to the device 20 associated with the coordinates in the device mapping holding section 211 corresponding to the received coordinate information.

In step S203, the device-state transmitter 213 transmits the information on the current state of the device 20 to the terminal apparatus 10 via the network 40. For example, the information is one that is not displayed on the appearance image to operate the device 20, specifically, information on the fact that the device 20 is not activated and is thus in the OFF state. Note that the transmission of the information on the current state of the device 20 may be performed at any timing.

### (4) Advantageous Effects

In the first embodiment of the invention, the terminal apparatus 10 receives the appearance image to operate the device 20 as web content from the device 20, and displays the received appearance image on the screen by use of a web browser. The terminal apparatus 10 is configured to be capable of making the device 20 perform the same processing as that performed when the user presses down a particular button or the like arranged in the remote control in accordance with the user's operation to click the particular button on the image with a mouse or the like even if the user does not use the remote controller itself.

According to the device-control system 1, the user can operate various devices 20 easily by use of the appearance images to operate the devices 20 displayed on the screen of the terminal apparatus 10.

In addition, the user who is familiar with the operation of the remote controller itself does not have to learn how to operate the system from the start, and can perform the operation immediately without committing errors.

In addition, the use of the terminal apparatus 10 allows the user to operate the device 20 via a network from a place so distant that the remote controller is not usable for operating the device 20.

In addition, the use of tabs allows the user to operate plural devices 20 efficiently by use of a single web-browser screen.

In addition, even if the user is not accustomed to the remote controller, the user can operate the device 20 by checking the description of how to operate. The balloon, voice, movie, or the like outputted when each of the buttons in the appearance image is clicked are used for the description.

### Second Embodiment

Now, description will be given of the following points according to a second embodiment of the invention: (1) the overall configuration of a device-control system; (2) the configurations of a terminal apparatus, of a device, and of a management server; (3) operations of the terminal apparatus, of the device, and of the management server; and (4) advantageous effects.

### (1) Overall Configuration of Device-Control System

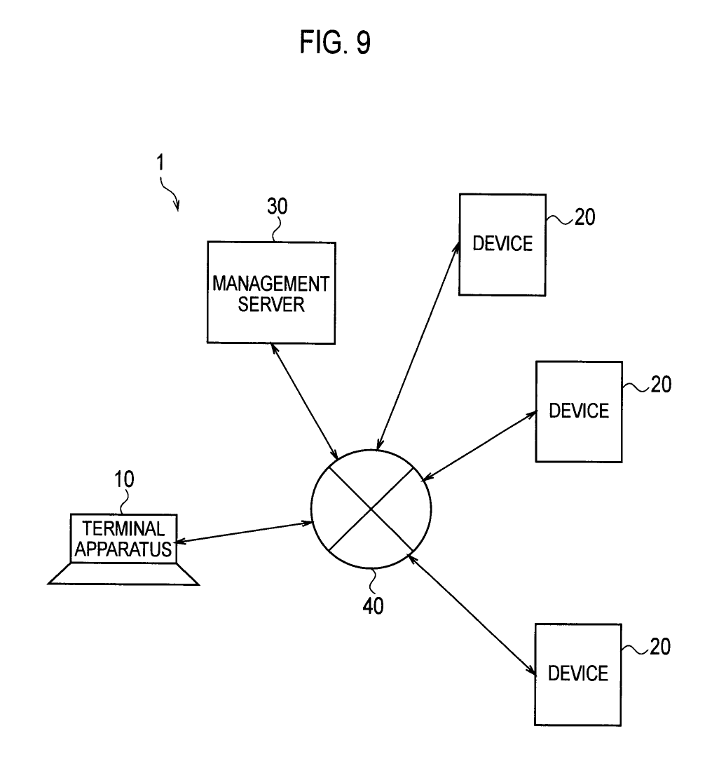

FIG. 9 is a diagram illustrating the overall configuration of a device-control system 1 according to the second embodiment of the invention.

As FIG. 9 shows, the device-control system 1 includes a terminal apparatus 10, devices 20, a management server 30, and a network 40.

The terminal apparatus 10 requires an appearance image to operate any of the devices 20 of the management server 30, via the network 40. Then, the terminal apparatus 10 receives the image sent by the management server 30 and displays the received image. The terminal apparatus 10 transmits operational information to the devices 20 via the network 40. The operational information is based on the operation to the displayed image in the terminal apparatus 10. Note that the terminal apparatus 10 may be a portable terminal apparatus.

The device 20 receives the operational information from the management server 30 via the network 40, and then performs processing in accordance with the operational information.

The management server 30 receives the operational information from the terminal apparatus 10 via the network 40, and transmits the received operational information to the device 20.

### (2) Configurations of Terminal Apparatus, of Device, and of Management Server

FIG. 2 is a block diagram illustrating the configuration of the terminal apparatus 10 according to the second embodiment of the invention.

The terminal apparatus 10 shown in FIG. 2 makes the device 20 perform processing in response to an operation performed by the user on the appearance image to operate the device 20. The terminal apparatus 10 is, for example, a personal computer. The terminal apparatus 10 includes a controller 110, a communication section 120, an operator 130, a monitor 140, and a memory section 150.

The controller 110 consists of a CPU, for example, and controls the variety of functions that the terminal apparatus 10 has.

The communication section 120 communicates with the management server 30 via the network 40.

The operator 130 includes a numerical keypad, function keys, and the like, and provides an interface used by the user to input the operational content. In addition, the operator 130 includes a mouse, which is a pointing device to be used, for example, to select a character string or the like displayed on the monitor 140.

The monitor 140 displays, for example, the image received via the controller 110, or the operational content.

The memory section 150 consists of a memory, for example, and stores various kinds of information to be used in the control performed by the terminal apparatus 10.

The controller 110 includes a terminal's receiver 111, a terminal's output processor 112, a terminal's mapping holding section 113, a terminal's transmitter 114, a terminal's device-state receiver 115, and a terminal's device-state output processor 116.

The terminal's receiver 111 receives an appearance image to operate the device 20 from the management server 30 via the network 40. To put it concretely, at first, the user directly input the URL of the web content associated with a list of the devices 20 that belong to the device-control system 1 into the web browser by using the operator 130. Then, the terminal apparatus 10 receives the list from the management server 30, and displays the received list. Further, the user selects a particular one of the devices 20 from the list, and then the terminal's receiver 111 receives the appearance image to operate the particular device 20 from the management server 30.

As FIG. 3 shows, the terminal's output processor 112 displays the image, received by the terminal's receiver 111, on the monitor 140. In addition, when the terminal apparatus 10 operates simultaneously plural ones of the devices 20 in accordance with the operation by the user, terminal's output processor 112 may displays tabs with the names of the plural devices 20 on the monitor 140 as FIG. 4 shows. In this case, if any of the tabs is clicked by use of a mouse or the like of the operator 130, the terminal's output processor 112 displays the appearance image to operate the device 20 associated with the clicked tab on the monitor 140. In addition, if a button or the like of the appearance image is clicked, the terminal's output processor 112 may display the description related to the button or the like on the monitor 140. To put it concretely, as FIG. 4 shows, the monitor 140 displays mode switching buttons of “remote-control operation” and of “how to use.” If the “how to use” button is pressed down and then any of the buttons of the appearance image is clicked, the terminal's output processor 112 explains the button of the appearance image by use of a balloon, voice, movie, or the like. In contrast, if the “remote-control operation” button is pressed down and then any of the buttons of the appearance image is clicked, the terminal's transmitter 114 performs processing.

As FIG. 5 shows, the terminal's mapping holding section 113 holds: coordinates in the appearance image to operate devices 20 that the terminal's output processor 112 makes the monitor 140 display; and processing commands which correspond respectively to the coordinates and which are dedicated to the devices 20. The coordinates and the processing commands are made to associate with each other.

The appearance image to operate one of the devices 20 is displayed on the monitor 140 by the terminal's output processor 112. If the appearance image is clicked by use of a mouse or the like of the operator 130, the terminal's transmitter 114 transmits to the device 20 the coordinate information on the clicked point and the name to identify the device 20. Alternatively, the terminal's transmitter 114 may transmit to the device 20 a processing command corresponding the coordinates information in the terminal's mapping holding section 113 and the name. Note that the coordinate information can be acquired from the type “image” attribute of the input tag of HTML, for example.

The terminal's device-state receiver 115 receives information on the current states of the devices 20 from the management server 30 via the network 40. For example, the information is one that is not displayed on the appearance image to operate the device 20, specifically, information on the fact that the device 20 is not activated and is thus in the OFF state.

As FIG. 3 shows, the terminal's device-state output processor 116 displays the information on the current state of the device 20 received by the terminal's device-state receiver 115 on the monitor 140. In addition, if the remote controller to operate device 20 has its own liquid crystal display (LCD) or the like that displays the current state of the device 20, the terminal's device-state output processor 116 displays the current state of the device 20 at the corresponding section in the appearance image in a manner similar to that shown in the LCD as FIG. 4 shows.

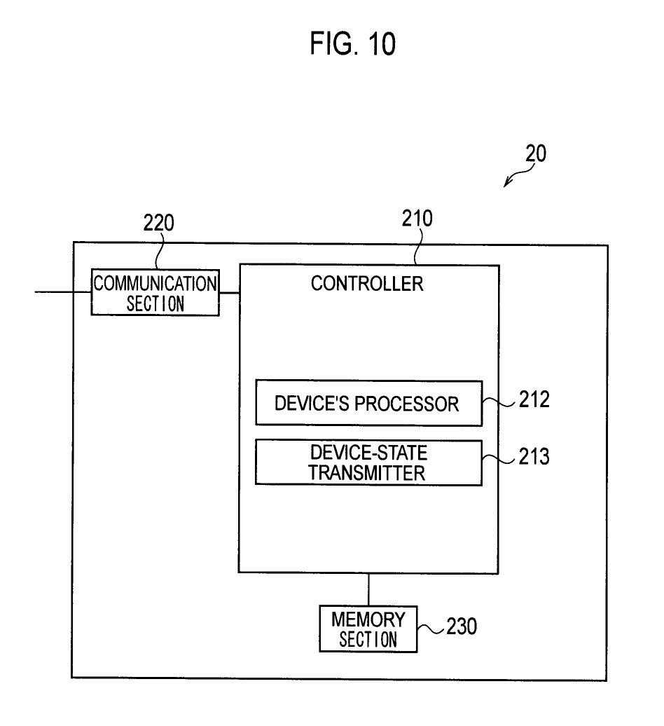

FIG. 10 is a block diagram illustrating the configuration of the device 20 according to the second embodiment of the invention.

The device 20 shown in FIG. 10 performs processing in response to the operation performed by the user on the terminal apparatus 10. The device 20 includes a controller 210, a communication section 220, and a memory section 230.

The controller 210 consists of a CPU, for example, and controls the variety of functions that the device 20 has.

The communication section 220 communicates with the terminal apparatus 10 via the network 40.

The memory section 230 consists of a memory, for example, and stores various kinds of information to be used in the control performed on the device 20.

The controller 210 includes a device's processor 212 and a device-state transmitter 213.

The device's processor 212 performs processing on the device 20 in accordance with the processing command dedicated to the device 20. The device 20 received the processing command from a server's operational-information transmitter 312 of the management server 30 via the network 40. Detailed description of the server's operational-information transmitter 312 will be given later.

The device-state transmitter 213 transmits information on the current state of the device 20 to the management server 30 via the network 40, either periodically or when a particular processing on the device 20 is finished. For example, the information is one that is not displayed on the appearance image to operate the device 20, specifically, information on the fact that the device 20 is not activated and is thus in the OFF state.

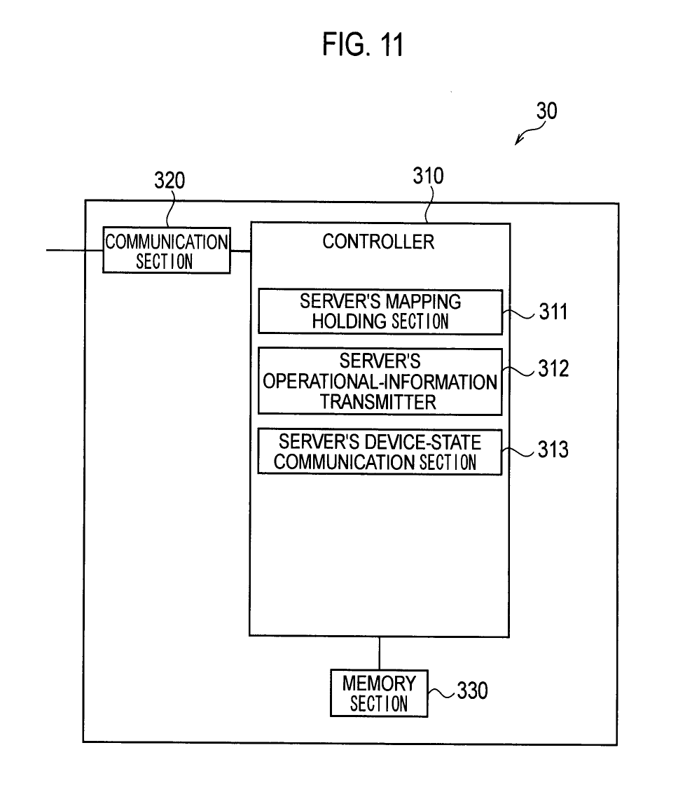

FIG. 11 is a block diagram illustrating the configuration of the management server 30 according to the second embodiment of the invention.

The management server 30 shown in FIG. 11 manages the devices 20 that belong to the device-control system 1. The management server 30 includes a controller 310, a communication section 320, and a memory section 330.

The controller 310 consists of a CPU, for example, and controls the variety of functions that the management server 30 has.

The communication section 320 communicates with both the terminal apparatus 10 and the device 20 via the network 40.

The memory section 330 consists of a memory, for example, and stores various kinds of information to be used in the control or the like performed by the management server 30.

The controller 310 includes a server's mapping holding section 311, the server's operational-information transmitter 312, and a server's device-state communication section 313.

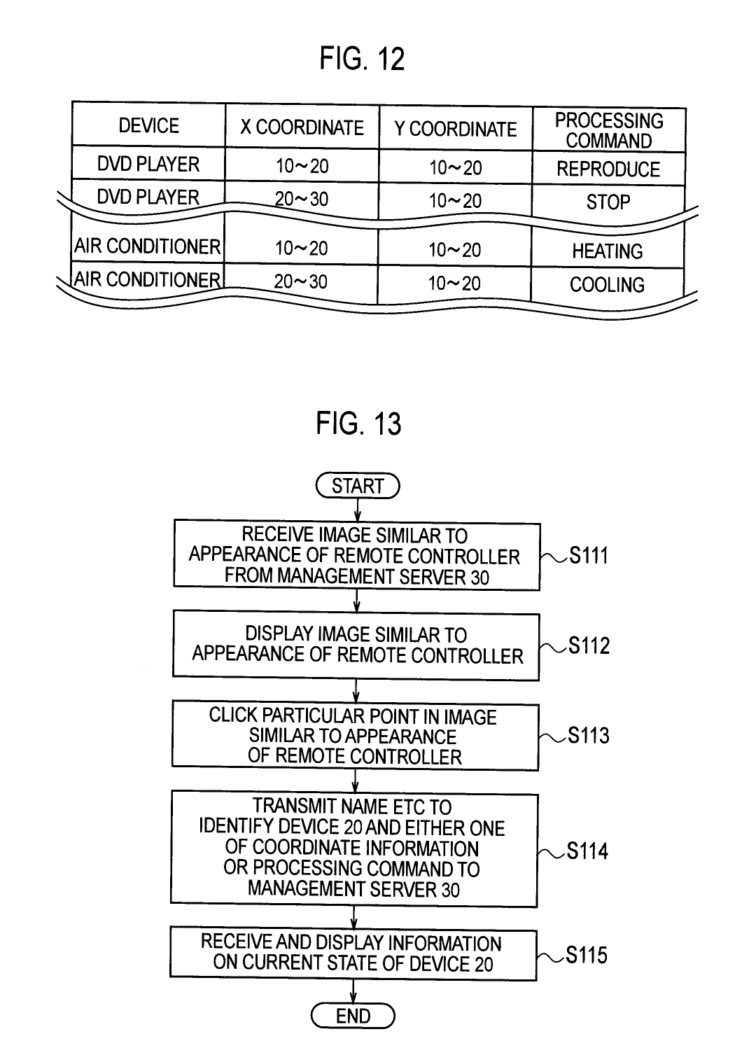

As FIG. 12 shows, the server's mapping holding section 311 holds: names or the like to identify the devices 20; particular sets of coordinates in the appearance image to operate devices 20 that are transmitted to the terminal apparatus 10; and processing commands which correspond respectively to the coordinates and which are to be given to the devices 20. The names or the like, the coordinates, and the processing commands are made to associate with one another.

The server's operational-information transmitter 312 receives a processing command dedicated to the device 20 from the terminal's transmitter 114 via the network 40, and transmits the received processing command to the device 20 identified by the name or the like to identify the device 20. In addition, the server's operational-information transmitter 312 receives a processing command dedicated to a device 20 from the terminal's transmitter 114 via the network 40, the processing command associated with the name or the like to identify the device 20 and with the coordinates held in the server's mapping holding section 311, and corresponding to the name or the like to identify the device 20 and the coordinate information. The server's operational-information transmitter 312 then transmits the received processing command to the device 20 identified by the name or the like to identify the device 20.

The server's device-state communication section 313 receives information on the current state of the device 20 from the device 20 via the network 40, and transmits the received information to the terminal apparatus 10 via the network 40. For example, the information is one that is not displayed on the appearance image to operate the device 20, specifically, information on the fact that the device 20 is not activated and is thus in the OFF state.

### (3) Operations of Terminal Apparatus, of Device, and of Management Server

Operations of the terminal apparatus, of management server, and of the device will be described.

FIG. 13 is a flowchart illustrating the operations of the terminal apparatus.

In step S111, the terminal's receiver 111 receives an appearance image to operate a particular one of the devices 20 from the management server 30 via the network 40 once the user to directly input the URL of the web content associated with the list of the devices 20 that belong the device-control system 1 into the web browser by using the operator 130, and then the user selects the particular one of the devices 20 from the displayed list.

In step S112, the terminal's output processor 112 displays the appearance image received by the terminal's receiver 111 on the monitor 140.

In step S113, the user clicks, by use of a mouse or the like of the operator 130, a particular point in the appearance image that the terminal's output processor 112 displays on the monitor 140.

In step S114, the terminal's transmitter 114 transmits the coordinate information on the clicked point and the name or the like to identify the device 20 to the management server 30. Alternatively, the terminal's transmitter 114 may transmit, to the management server 30, the name or the like to identify the device 20 and a processing command dedicated to the device 20. The processing command is associated with the coordinates in the terminal's mapping holding section 113, the processing command corresponding to the coordinate information.

In step S115, the terminal's device-state receiver 115 receives information on the current state of the device 20 from the management server 30 via the network 40. For example, the information is one that is not displayed on the appearance image to operate the device 20, specifically, information on the fact that the device 20 is not activated and is thus in the OFF state. The terminal's device-state output processor 116 140 displays the information on the current state of the device 20 thus received by the terminal's device-state receiver 115 on the monitor 140. Note that the reception and the display of the information on the current state of the device 20 may be performed at any timing.

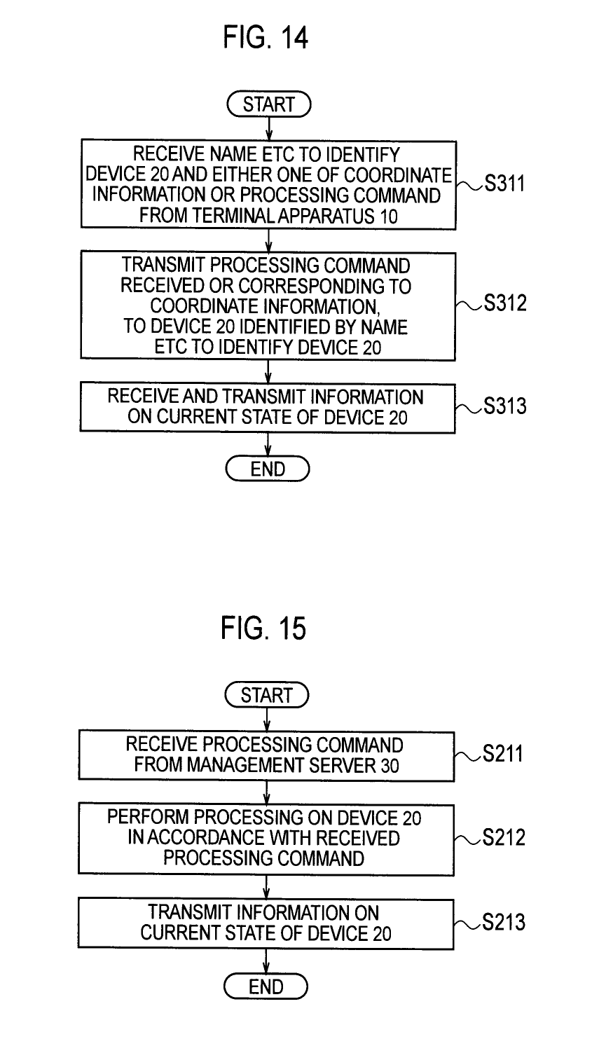

FIG. 14 is a flowchart illustrating the operations of the management server 30.

In step S311, the controller 310 receives either the coordinate information or the processing command dedicated to the device 20 from the terminal apparatus 10, via the network 40. The controller also receives the name or the like to identify the device 20.

In step S312, the server's operational-information transmitter 312 transmits the processing command dedicated to the device 20 received from the terminal's transmitter 114, via the network 40 to the device 20 identified by the name or the like to identify the device 20 received from the terminal's transmitter 114. In addition, the server's operational-information transmitter 312 receives a processing command dedicated to a device 20 from the terminal's transmitter 114 via the network 40, the processing command associated with the name or the like to identify the device 20 and with the coordinates held in the server's mapping holding section 311, and corresponding to the name or the like to identify the device 20 and the coordinate information. The server's operational-information transmitter 312 then transmits the received processing command to the device 20 identified by the name or the like to identify the device 20.

In step S313, server's device-state communication section 313 receives information on the current state of the device 20 from the device 20 via the network 40, and transmits the received information to the terminal apparatus 10 via the network 40. For example, the information is one that is not displayed on the appearance image to operate the device 20, specifically, information on the fact that the device 20 is not activated and is thus in the OFF state. Note that the transmission of the information on the current state of the device 20 may be performed at any timing.

FIG. 15 is a flowchart illustrating the operations of the device 20.

In step S211, the controller 210 receives the processing command dedicated to the device 20 from the management server 30, via the network 40.

In step S212, the device's processor 212 performs processing on the device 20 in accordance with the received processing command.

In step S213, the device-state transmitter 213 transmits the information on the current state of the device 20 to the management server 30 via the network 40. For example, the information is one that is not displayed on the appearance image to operate the device 20, specifically, information on the fact that the device 20 is not activated and is thus in the OFF state. Note that the transmission of the information on the current state of the device 20 may be performed at any timing.

### (4) Advantageous Effects

In the second embodiment of the invention, the terminal apparatus 10 receives the appearance image to operate the device 20 as web content from the management server 30, and displays the received appearance image on the screen by use of a web browser. The terminal apparatus 10 is configured to be capable of making the device 20 perform the same processing as that performed when the user presses down a particular button or the like arranged in the remote controller in accordance with the user's operation to click the particular button on the image with a mouse or the like even if the user does not use the remote controller itself.

According to the device-control system 1, the user can operate various devices 20 easily by use of the appearance images to operate the devices 20 displayed on the screen of the terminal apparatus 10.

In addition, the user who is familiar with the operation of the remote controller itself does not have to learn how to operate the system from the start, and can perform the operation immediately without committing errors.

In addition, the use of the terminal apparatus 10 allows the user to operate the device 20 via a network from a place so distant that the remote controller is not usable for operating the device 20.

In addition, the use of tabs allows the user to operate plural devices 20 efficiently by use of a single web-browser screen.

In addition, even if the user is not accustomed to the remote controller, the user can operate the device by checking the description of how to operate. The balloon, voice, movie, or the like outputted when each of the buttons in the appearance image is clicked are used for the description.

In addition, the management server 30 manages the devices 20 that belong to the device-control system 1. Accordingly, even if the user does not know the URLs of the devices 20, the user can make each of the devices 20 perform processing as long as the user knows the URL of the management server 30.

### Other Embodiments

The invention has been described as above by use of some embodiments. However, it should not be understood that the description and drawings which constitute part of this disclosure limit the present invention. From this disclosure, various alternative embodiments, examples, and operation techniques will be easily found by those skilled in the art.

In the above-described first embodiment, to make the terminal apparatus 10 receive the appearance image to operate the device 20 and to cause the device 20 to perform processing, the user directly inputs the URL of the web content associated with the image into the web browser. It is however possible that the device-control system 1 include a link server to provide, to the terminal apparatus 10, a web content including only plural links respectively to the plural devices 20. As long as the user knows only the URL of the link server, the terminal apparatus 10 can acquire, from the link server, the web content including only the plural links respectively to the plural devices 20. In addition, if the user selects one of the plural links respectively to the plural device 20 included in the web content, terminal apparatus 10 can access the selected one of the devices 20 by use of the URL of the selected device 20 associated with the selected link.

In addition, in the first and the second embodiments described above, the appearance image to operate the device 20 is a web content, but this is not the only possible way of providing the appearance image.

It should be understood that the present invention naturally includes various other embodiments that are not described in this specification. Accordingly, the present invention should be limited only by the matters to define the invention in the scope of claims regarded as appropriate based on the description.

### INDUSTRIAL APPLICABILITY

The device-control system, the terminal apparatus, and the device of the invention, the device can be operated easily by use of the image displayed on the screen of the terminal apparatus, so that the device-control system, the terminal apparatus, and the device of the invention are useful as a device-control system, a terminal apparatus, and a device.

What is claimed is:

1. A device-control system which includes a device capable of being operated by a remote controller and a terminal apparatus capable of displaying an image, and which controls the device via a network, wherein the terminal apparatus includes
an output section;
a terminal's receiver for receiving an image similar to an appearance of the remote controller for operating the device;
a terminal's output processor for causing the output section to output the image received by the terminal's receiver; and
a terminal's transmitter for transmitting the operational information generated by an operation performed by use of the terminal apparatus with respect to the image outputted by the terminal's output processor, and wherein the device includes a device's processor for performing processing operations in accordance with the operational information.

2. The device-control system according to claim 1, wherein the terminal's receiver receives an image similar to the appearance of the remote controller for operating the device.

3. The device-control system according to claim 1, wherein the terminal's receiver receives the image from the device, and the terminal's transmitter transmits the operational information to the device.

4. The device-control system according to claim 3, wherein
the terminal's transmitter transmits as operational information a processing command that is dedicated to the device and that corresponds to the coordinate information indicating a point selected on the image, and wherein
the device's processor performs processing in accordance with the processing command as the operation information received from the terminal apparatus and serving as the operational information.

5. The device-control system according to claim 3,
wherein the terminal's transmitter transmits as operational information the coordinate information indicating a point selected on the image to the device, and
the device's processor performs processing in accordance with a processing command dedicated to the device and corresponding to the coordinate information as the operational information received from the terminal apparatus.

6. The device-control system according to claim 3, further comprising a link server for linking the terminal apparatus to the device.

7. The device-control system according to claim 1, further comprising a management server for managing the device,
wherein the terminal's receiver receives the image from the management server, and
the terminal's transmitter transmits the operational information to the management server.

8. The device-control system according to claim 7,
wherein the management server includes a server's operational-information transmitter;
the terminal's transmitter transmits that processing command as the operational information which is dedicated to the device and corresponds to the coordinate information indicating a point selected on the image;
the server's operational-information transmitter transmits to the device the processing command received from the terminal apparatus and serving as the operational information; and
the device's processor performs processing in accordance with the processing command received from the management server and serving as the operational information.

9. The device-control system according to claim 7,
wherein the management server includes a server's operational-information transmitter;
the terminal's transmitter transmits to the management server the coordinate information indicating a point selected on the image and serving as the operational information;
the server's operational-information transmitter transmits to the device that processing command dedicated to the device which serves as the operational information and corresponds to the coordinate information received from the terminal apparatus; and
the device's processor performs processing in accordance with the processing command received from the management server and serving as the operational information.

10. The device-control system according to claim 1, wherein the terminal's output processor causes the output section to output explanatory information providing explanation corresponding to the coordinate information indicating a point selected on the image.

11. The device-control system according to claim 1,
wherein, when a plurality of devices are controlled via the network, the terminal's output processor causes the output section to output display regions to be used for identifying the plural devices in association with the respective devices, and
the terminal's output processor causes the output section to output the image associated with the device identified by selecting any one of the display regions.

12. The device-control system according to claim 1,
wherein the device further includes a device-state transmitter;
the terminal apparatus further includes a terminal's device-state receiver and a terminal's device-state output processor;
the device-state transmitter transmits state information indicating the current state of the device;
the terminal's device-state receiver receives the state information; and
the terminal's device-state output processor causes the output section to output an image corresponding to the state information received by the terminal's device-state receiver.

13. The device-control system according to claim 12, wherein when the remote controller includes a display section to display the state information,
the terminal's device-state output processor causes the output section to output the image corresponding to the state information received by the terminal's device-state receiver in a region within the image corresponding to the display section.

14. A terminal apparatus which communicates via a network with a device operable by a remote controller and which displays an image, the terminal apparatus comprising:
an output section;
a terminal's receiver for receiving an image similar to the appearance of the remote controller for operating the device;
a terminal's output processor for causing the output section to output the image received by the terminal's receiver; and
a terminal's transmitter for transmitting operational information generated by an operation performed by use of the terminal apparatus with respect to the image outputted by the terminal's output processor.

15. A device which communicates via a network with a terminal apparatus capable of displaying an image and which can be operated by use of a remote controller, the device comprising a device's processor for performing processing in accordance with the operational information, if the terminal apparatus displays an image similar to the appearance of the remote controller for operating the device, and transmits the operational information generated by an operation performed with respect to the image by use of the terminal apparatus.
